(19) United States
(12) Patent Application Publication
(10) Pub. No.: US 2001/0022289 A1
(43) Pub. Date: Sep. 20, 2001

(54) Air filtering material for air cleaning

(76) Inventors: Kazutaka Yokoyama, Wako-shi (JP); Daisuke Susa, Wako-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/774,005

(22) Filed: Jan. 31, 2001

(30) Foreign Application Priority Data
Feb. 3, 2000 (JP) 2000-26398

(51) Int. Cl. B01D 59/12

(52) U.S. Cl. 210/500.23; 210/505

(57) ABSTRACT

An air filtering material for air cleaning is formed of a nonwoven fabric of hollow chemical fibers having axial holes containing an oil. The oil exudes through the open ends of the axial holes to wet the surfaces of the hollow chemical fibers to enhance the filtering ability of the air filtering material by binding dust particles by the sticky oil.

### BACKGROUND OF THE INVENTION

1. Field of the Invention

The present invention relates to an air filtering material for air cleaning capable of removing dust from air.

2. Description of the Related Art

JP-A No. Hei 11-156123 discloses an air cleaning device capable of collecting dust at a high collection efficiency. The air cleaning device has a coarse filter unit provided with a coarse air filtering material and a fine air filtering unit provided with a fine air filtering material in combination and is intended to filter dust at a high collection efficiency and to use the filtering materials for an extended period of time.

Filter paper as air filtering material catches dust particles in spaces between fibers. A nonwoven fabric of chemical fibers as air filtering material catches small dust particles by the agency of static electricity accumulated on the surfaces of the chemical fibers and catches large dust particles in spaces between the chemical fibers. Therefore, the spaces between the fibers must be miniaturized to improve cleaning efficiency, i.e., collection efficiency. However, the miniaturization of spaces between the fibers entails increase in the airflow resistance of the air filtering material and, when an air cleaner provided with such an air filtering material is placed in the intake system of an internal combustion engine, the air cleaner reduces the combustion efficiency of the internal combustion engine.

An air filtering material formed by oiling filter paper is capable of cleaning air at a high cleaning efficiency by the combined effect of catching dust particles in spaces between fibers and binding dust particles by the sticky oil. However, the airflow resistance of the filter paper cannot be reduced by expanding the spaces between the fibers of the filter paper because the oil is held in the minute spaces between the fibers of the filter paper by surface tension. It is difficult to hold an oil on a nonwoven fabric of chemical fibers because chemical fibers, in general, have smooth surfaces and the oil is unable to adhere easily to the surfaces of the chemical fibers.

### SUMMARY OF THE INVENTION

The present invention has been made in view of those problems and it is therefore an object of the present invention to provide an air filtering material for air cleaning, capable of cleaning air at a high cleaning efficiency and at a low airflow resistance.

According to the present invention, an air filtering material is formed of a nonwoven fabric of hollow chemical fibers having axial holes containing an oil. The oil contained in the axial holes of the chemical fibers exudes through the open ends of the axial holes. Therefore, large and small dust particles can be collected at a high collection efficiency by the combined effect of catching dust particles in spaces between the chemical fibers and binding dust particles by the oil even if the chemical fibers are distributed coarsely to reduce the airflow resistance of the air filtering material.

In the air filtering material for air cleaning, it is preferable that the hollow chemical fibers have narrow openings similar to cracks and fissures and reaching the axial holes thereof. The oil exudes through the narrow openings to wet the surfaces of the chemical fibers, so that dust particles can be bound by the oil wetting the surfaces of the chemical fibers, which further improves the cleaning efficiency of the air filtering material.

### BRIEF DESCRIPTION OF THE DRAWINGS

The above and other objects, features and advantages of the present invention will become more apparent form the following description taken in connection with the accompanying drawings, in which:

FIG. 1 is an enlarged, fragmentary perspective view of a hollow chemical fiber for forming an air filtering material according to the present invention;

FIG. 2 is an enlarged, fragmentary perspective view of another hollow chemical fiber for forming an air filtering material embodying the present invention;

FIG. 3 is an enlarged, fragmentary perspective view of a hollow chemical fiber having fissures;

FIG. 4 is an enlarged, fragmentary perspective view of a hollow chemical fiber having cracks;

FIG. 5 show tables showing the characteristics of air filtering materials according to the present invention and conventional air filtering materials;

FIG. 6 is a schematic side elevation of a testing machine for collection efficiency measurement;

FIG. 7 is a graph comparatively showing cleaning efficiencies of air filtering materials according to the present invention and those of conventional air filtering materials for airflow resistances; and

FIG. 8 is a graph comparatively showing airflow resistances of air filtering materials according to the present invention and those of conventional air filtering materials for cleaning efficiencies.

### DESCRIPTION OF THE PREFERRED EMBODIMENTS

Filtering materials for air cleaning according to the present invention will be described as applied to a cleaning element of an air cleaner to be placed in the intake system of an internal combustion engine.

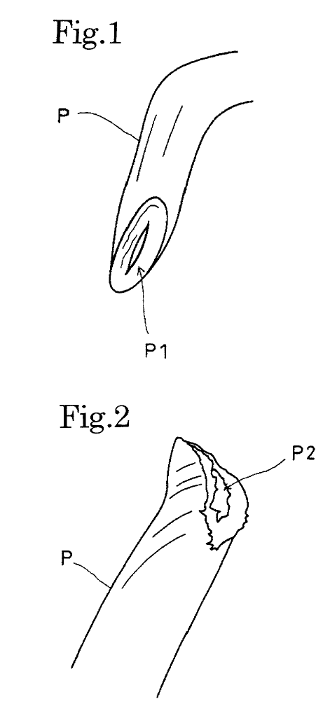

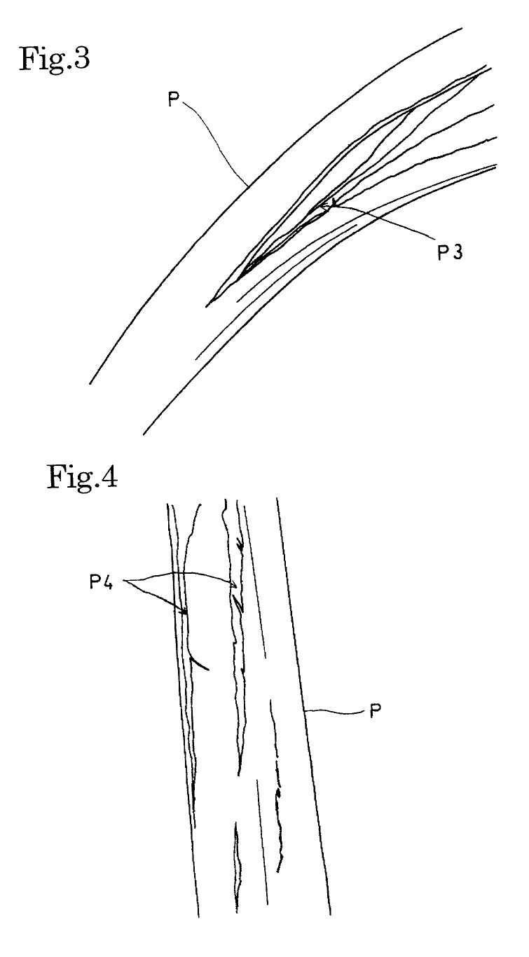

An air filtering material is formed by impregnating hollow polyester fibers P forming a nonwoven fabric and having axial holes with an oil. A hollow fiber P shown in FIG. 1 has a clean end P1 like that formed by cutting the hollow fiber P with a sharp knife. A hollow fiber P shown in FIG. 2 has a rugged end P2 like that formed by tearing off the hollow fiber P. The oil contained in the axial hollows of the hollow fibers P exudes through the open ends of the axial hollows opening in the ends P1 and P2.

The hollow fiber P does not have a regularly tubular shape; the hollow fiber P has fissures P3 reaching its axial hole as shown in FIG. 3 or cracks P4 reaching its axial hole as shown in FIG. 4. The oil contained in the axial hole is able to exude through the fissures P3 or the cracks P4. In some cases, many fissures P3 or cracks P4 are formed deliberately in the hollow fiber P so that the oil is able to spread over the surface of the hollow fiber P.

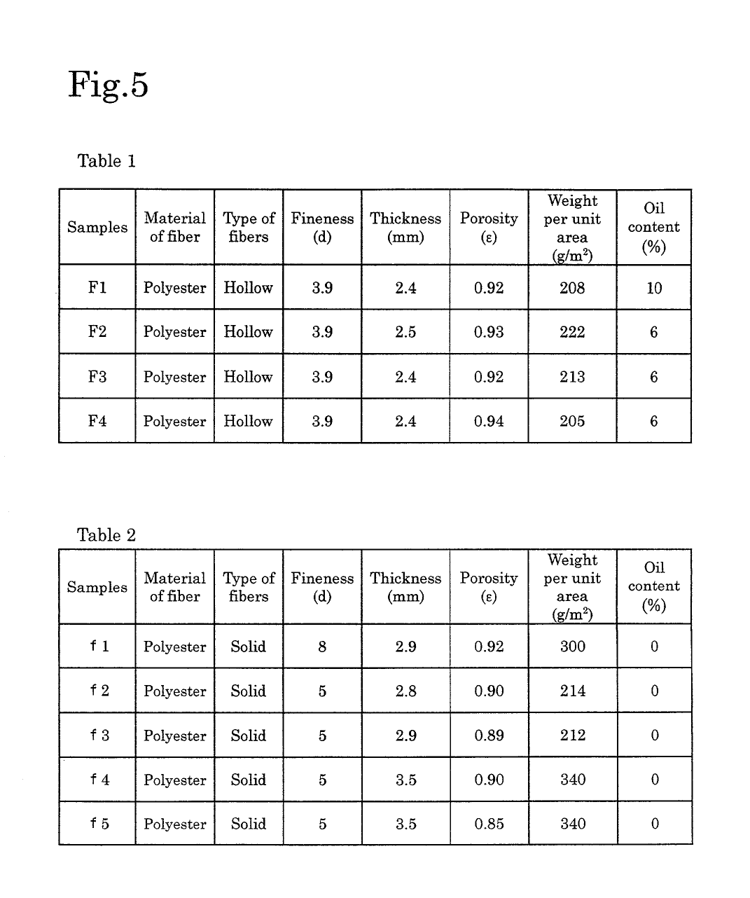

Four examples F1, F2, F3 and F4 of air filtering materials according to the present invention were prepared by cutting nonwoven fabrics of polyester hollow fibers impregnated with an oil according to the present invention and having different properties as shown in Table 1 shown in FIG. 5. Five comparative examples f1, f2, f3, f4 and f5 of conventional air filtering materials were prepared by cutting nonwoven fabrics of ordinary round polyester fibers having a round section and not impregnated with oil and having different properties as shown in Table 2 shown in FIG. 5. The examples F1 to F4 and the comparative examples f1 to f5 were tested to measure cleaning efficiency and airflow resistance. In Tables 1 and 2, the fineness of the fibers is expressed in denier (d=50 mg/450 m).

The respective airflow resistances of the examples F1, F2 and F3 were substantially equal to those of the comparative examples f1, f2 and f3. The respective cleaning efficiencies of the examples F4 and F3 were substantially equal to those of the comparative examples f4 and f5.

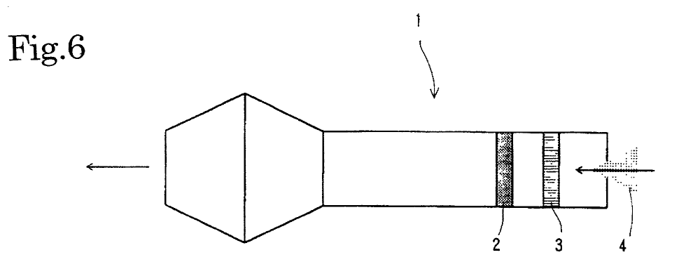

An air filtering material testing device 1 shown in FIG. 6 was used for testing the air filtering materials for cleaning efficiency. As shown in FIG. 6, the air filtering material testing device 1 has a duct having a tubular portion of 70 mm in inside diameter, an expanding portion extending from the lower end of the tubular portion and expanding toward its lower end, and a tapering portion extending from the lower end of the expanding portion and tapering toward its lower end. An absolute filter 2 capable of completely removing dust from air was placed at a middle position in the tubular portion. A test sample 3 of the air filtering material was placed at a position above the absolute filter 2 in the tubular portion of the duct. Standard dust 4, such as the test dust of Class 8(fine) specified in JIS Z 8901, for testing the performance of automotive air cleaners was used for tests. About 2 g of standard dust 4 was added to air flowing at 1 m³/min through the duct of the air filtering material testing device 1. The weight of the sample 3 before the test and that of the same after the test were measured, and the difference between the weight before the test and the weight after the test was calculated to determine a collected dust weight A, i.e., the weight of the dust collected by the sample 3. The weight of the absolute filter 2 before the test and that of the same after the test were measured, and the difference between the weight before the test and the weight after the test was calculated to determine an absolute collected dust weight B, i.e., the weight of the dust collected by the absolute filter 2. Cleaning efficiency was calculated by using the following expression.

Cleaning efficiency={A/(A+B)}×100 (%)

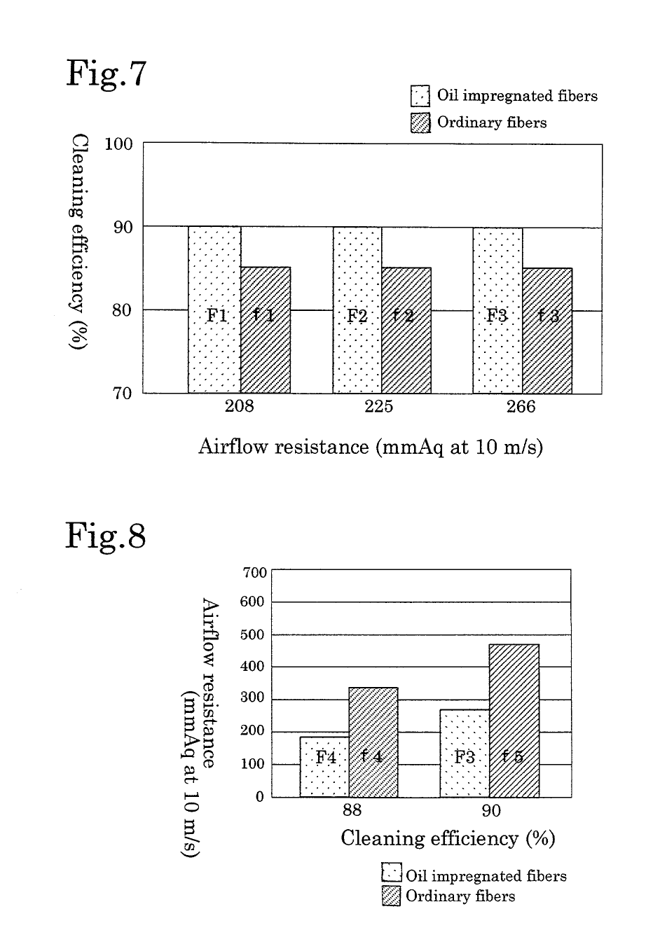

As shown in FIG. 7, the cleaning efficiency of the examples F1, F2 and F3 of the air filtering materials according to the present invention respectively having airflow resistances of 208, 225, 266 mmAq at 10 m/s was 90%, while the cleaning efficiency of the comparative examples f1, f2 and f3 of the conventional air filtering materials was lower than that of the examples F1, F2 and F3. The cleaning efficiency of the examples F1, F2 and F3 was higher than that of the comparative examples f1, f2 and f3 by about 5%, because the present invention improves cleaning efficiency by catching dust particles by the oil exuded from the axial holes of the fibers and wetting the surfaces of the fibers in addition to catching dust particles in spaces between the fibers instead of improving cleaning efficiency by increasing the density of the fibers.

It is obvious from FIG. 8 comparatively showing the airflow resistances of the comparative examples f4 and f5 respectively having cleaning efficiencies 88% and 90% and the examples F4 and F3 respectively having the same cleaning efficiencies as the comparative examples F4 and f5 that the airflow resistance of the air filtering materials of the present invention are far lower than that of the conventional air filtering materials.

As apparent from the foregoing description, the air filtering material of the present invention includes hollow chemical fibers having axial holes containing the oil and is capable of catching dust particles by the oil exuded from the axial holes and wetting the surfaces of the hollow chemical fibers in addition to catching dust particles in spaces between the hollow chemical fibers. Consequently, the air filtering material exerts a low airflow resistance on air flowing through it and is able to achieve a high cleaning efficiency. When the air filtering material is used for forming the cleaner element of an air cleaner to be placed in the intake system of an internal combustion engine, intake air can be cleaned at a high cleaning efficiency, and the internal engine is able to operate at a high combustion efficiency because the airflow resistance of the cleaner element is low.

The conventional air filtering material that catches dust particles only in spaces between the fibers is clogged with a small amount of dust and its airflow resistance increases greatly. Since the oil wetting the surfaces of the hollow chemical fibers of the air filtering material of the present invention catches dust particles, the air filtering material is not clogged easily even if a large amount of dust is caught by the air filtering material and has a large filtering capacity; that is, the air filtering material of the present invention has an extended service life.

The hollow chemical fibers may be have, in addition to fissures and cracks, many fine thorns on their surfaces. The oil can be held between such fine thorns, which enhances the dust catching ability of the hollow chemical fibers to improve cleaning efficiency.

Although the invention has been described in its preferred embodiment with a certain degree of particularity, obviously many changes and variations are possible therein. It is therefore to be understood that the present invention may be practiced otherwise than as specifically described herein without departing from the scope and spirit thereof.

What is claimed is:

1. An air filtering material for air cleaning formed of a nonwoven fabric of hollow chemical fibers having axial holes containing an oil.

2. The air filtering material according to claim 1, wherein the hollow chemical fibers have narrow openings similar to cracks and fissures and reaching the axial holes thereof.
